(19) United States
(12) Patent Application Publication
(10) Pub. No.: US 2024/0109636 A1
(43) Pub. Date: Apr. 4, 2024

(54) ADJUSTABLE MARINE DRIVE SYSTEM WITH AUTOMATIC CLEANING

(71) Applicant: VOLVO PENTA CORPORATION, Göteborg (SE)

(72) Inventor: Lennart ARVIDSSON, Kållered (SE)

(73) Assignee: VOLVO PENTA CORPORATION, Göteborg (SE)

(21) Appl. No.: 18/477,771

(22) Filed: Sep. 29, 2023

Related U.S. Application Data
(63) Continuation of application No. PCT/EP2022/077242, filed on Sep. 30, 2022.

(51) Int. Cl. B63H 21/30; B08B 1/00; B08B 1/02; B63H 21/21

(52) U.S. Cl. CPC B63H 21/30; B08B 1/005; B08B 1/02; B63H 21/21

(57) ABSTRACT

A drive system for a marine vessel including a first housing fixed to an opening in a hull of the marine vessel, and a drive unit arranged inside the first housing. The drive unit is provided with a second housing comprising an electric or combustion drive motor and a marine propulsion system attached to the second housing. The drive system is provided with a parking position in which the marine propulsion system is positioned inside the first housing, a drive position in which the marine propulsion system is positioned outside of the first housing and an intermediate position in which the marine propulsion system is positioned between the parking position and the drive position.

### TECHNICAL FIELD

The present invention relates to a marine drive system in which the position of the propeller setup arrangement can be adjusted. The drive system is positioned in a housing mounted inside the hull of a marine vessel, and the propeller can be lowered from a parking position to a drive position. In the parking position, the drive system is provided with an automatic cleaning sequence.

### BACKGROUND ART

Electric propulsion of vehicles is getting more and more common in order to replace combustible fuels. Slowly, electrical propulsion of marine vehicles are also gaining more interest. Electrical drive systems for slower boats, such as gigs or sailboats, are relatively energy efficient when the boat travels at low speeds. A further advantage for sailboats is that they normally do not need the motor, and that the motor is mostly used in emergencies and when docking. In such cases, an electric drive may be plausible.

Smaller sailboats are often provided with an outboard combustion motor that is used to drive the sailboat when there is no wind or when docking. Larger sailboats have an inboard combustion engine that is either provided with a straight axle that drives a propeller arranged at the rear of the sailboat, or is provided with a so called saildrive mounted to the hull of the sailboat. The saildrive may be provided with a fixed propeller or a foldable propeller. A foldable propeller will induce less drag when sailing, but is not suitable for charging a battery when sailing. A fixed propeller induce more drag when sailing but is more suited for charging a battery when sailing. When charging a battery, the propeller is connected to a generator that is powered by the propeller which will induce some drag. When not charging, the propeller is disconnected from the generator and rotates more or less freely, but will still induce a small amount of drag.

WO 2018198063 and US 2014022097 show examples of a fixed propeller that can be retracted into the hull of a boat. In a retracted position, drag is minimized and the propeller is less vulnerable.

Even if these systems functions well for their intended use, there is room for an improved drive system for a marine vessel.

### DISCLOSURE OF INVENTION

An object of the invention is therefore to provide an improved drive system for a marine vessel. A further object of the invention is to provide a marine vessel comprising such a drive system.

The solution to the problem according to the invention is defined by the features of the main claims. The other claims contain advantageous further developments of the drive system.

In a drive system for a marine vessel comprising a first housing fixed to an opening in a hull of the marine vessel, and a drive unit arranged inside the first housing, where the drive unit comprises a second housing comprising a drive motor and a marine propulsion system attached to the second housing, where the marine propulsion system comprises a leg and a hub provided with at least one propeller, where the drive system comprises an adjustment mechanism arranged to adjust the position of the drive unit in the first housing, where the drive system is provided with a parking position in which the marine propulsion system is positioned inside the first housing and a drive position in which the marine propulsion system is positioned outside of the first housing, the object of the invention is achieved in that the drive system is provided with an intermediate position in which the marine propulsion system is positioned between the parking position and the drive position.

By this first embodiment of the drive system for a marine vessel, the height position of the propeller can be adjusted. In a parking position, the complete drive unit is positioned within the first housing and thus within the hull of the marine vessel, such that the propeller is completely concealed. In this position, the marine propulsion system and the propeller will not induce any drag which is of advantage when sailing. A further advantage is that the marine propulsion system is less prone to be subjected to biofouling. By filling the space with a gas, such as air or exhaust gas, the biofouling problem is further minimized. In a drive position, the lower side of the second housing of the drive unit is aligned with the hull, and the marine propulsion system extends completely into the water. This position is used when the boat is driven by the motor, and can also be used when the battery needs to be charged when sailing. The marine vessel may be a sailboat or a motorboat. The drive motor is in one example an electric drive motor, and in another example a combustion engine.

The drive system is provided with a programmable automatic cleaning sequence that is used when the marine vessel is parked and when the drive unit is in the parking position. In the programmable cleaning sequence, the drive unit is moved automatically from the parking position to the drive position and back to the parking position. The cleaning sequence may be performed once or may be repeated several times. When the marine vessel is parked, the cleaning sequence is performed automatically with a predetermined interval that can be set by the manufacturer of the boat or may be set by the user of the boat. The time interval is in one example once a day, i.e. a time interval of around 24 hours. Other suitable time intervals may be e.g. every second day or once a week.

The time interval may also be set depending on environmental parameters. The time of the year is one parameter. Other parameters are e.g. the geographical position, the type of water or the temperature of the water. All these parameters may influence the cleaning need of the drive system. The time of the year and the geographical position will e.g. determine the amount of different marine vegetation and marine animals that may grow and pollute the drive system. Barnacles is one such example, which will give more problems at some locations and at some time frames. They will e.g. often settle in autumn.

The first housing and the second housing have the same shape, and may be circular or non-circular. A circular shape may be of advantage if the drive unit is to be rotated in the first housing, e.g. for steering of the vessel. A non-circular shape may be of advantage if the rotational orientation of the drive unit should be fixed. By using a non-circular shape for the first housing and the second housing, there is no need to use an anti-rotational means to hold the drive unit in a fixed position.

The position of the drive unit may be controlled manually by a user, or may be automatically controlled. A user may e.g. start a cleaning sequence manually if the boat has been driven in e.g. muddy waters or in seaweed. A user may further retract the drive unit when the boat is parked.

The position of the drive unit may also be controlled automatically by an ECU. In one example, the drive unit is lowered when the electric motor is engaged, e.g. when a user selects the drive mode of the boat, and the drive unit is retracted when the drive mode is deselected. The ECU will also control the automatic cleaning sequence.

The height position of the drive unit in the first housing is controlled by an adjustment mechanism that extends and retracts the drive unit out of and into the first housing. The position may e.g. be set with a linear actuator of some kind, such as a hydraulic cylinder or an electric linear actuator. The adjustment mechanism may also comprise a locking means that fixates the drive unit in the selected position. The locking means may e.g. be a self-locking gear of an electric motor that is used to position the drive unit in the first housing.

In one example, the first housing and the second housing are circular. The drive unit is in one example rotationally fixed in the first housing, such that it cannot rotate and such that the propeller is directed in a fixed orientation. In another example, the drive unit is rotationally adjustable such that the propeller can be directed in any desired direction. In this example, the drive unit can be used to steer the boat. The drive unit may be provided with a single propeller or with two propellers that rotate in different directions.

### BRIEF DESCRIPTION OF DRAWINGS

The invention will be described in greater detail in the following, with reference to the attached drawings, in which

FIG. 1 shows a schematic marine vessel provided with a drive system according to the invention,

FIG. 2 shows the drive unit in the parking position, and

FIG. 3 shows the drive unit in the drive position.

### MODES FOR CARRYING OUT THE INVENTION

The embodiments of the invention with further developments described in the following are to be regarded only as examples and are in no way to limit the scope of the protection provided by the patent claims.

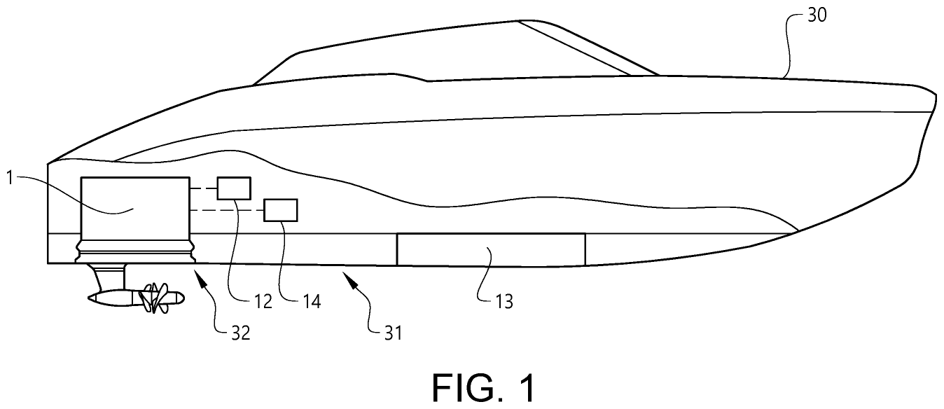

FIG. 1 shows a schematic marine vessel 30 provided with a drive system 1 for propelling the marine vessel or for generating electric energy. The drive system 1 comprises a first housing 2 that is mounted to an opening 32 in the hull 31 of the marine vessel 30. The opening 16 of the first housing 2 is mounted flush with the hull such that the first housing 2 does not extend out of the hull. The first housing is fixedly mounted to the hull. The opening 16 is provided with a flange 17 extending inwards from the inner side of the first housing. The flange 17 may be straight or angled. The vessel is also provided with a gas pressure source 14 that can supply pressurized gas, such as air or another suitable gas.

A drive unit 3 is arranged inside the first housing 2. The drive unit 3 comprises a second housing 4 that comprises a drive motor 5 that drives a drive shaft to the propeller 9. The drive shaft may be driven directly by the drive motor and may be directly attached to the drive motor, or may be driven through a transmission of some type. The drive unit may also comprise an electronic control unit (ECU) 12 used to control the drive motor. The second housing 4 is arranged to slide inside the first housing 2 such that the position of the drive unit in the first housing 2 can be adjusted. The second housing is in one example watertight.

The drive motor 5 is in one example an electric motor powered by a battery 13. One advantage of using an electric drive motor is that the motor can also be used to charge the battery when the drive system is installed in a sailboat. The drive motor may also be an internal combustion engine, either fuelled by petrol or diesel. In the shown example, an electric motor is used as the drive motor.

A marine vessel 30 may be provided with one or more drive systems 1. A smaller regular sailboat may e.g. be provided with a single drive system that is rotationally fixed and that replaces a regular saildrive installation, where the sailboat is steered with a rudder. Larger sailboats may also be provided with two or more drive systems, which may be either rotationally fixed or rotatable. The drive system is also suitable for motorboats. A smaller motorboat may e.g. be provided with a single drive system where the boat is steered by rotating the drive unit. A larger motorboat may be provided with two or more drive systems, where the steering may be performed by either driving the propellers with different rotational speeds or by rotating the drive units.

The first housing and the second housing have the same shape, and may be circular or non-circular. A circular shape may be of advantage if the drive unit is to be rotated in the first housing, e.g. for steering of the vessel. A non-circular shape may be of advantage if the rotational orientation of the drive unit should be fixed. By using a non-circular shape for the first housing and the second housing, there is no need to use an anti-rotational means to hold the drive unit in a fixed position.

The edge 18 of the lower side 15 of the second housing 4 is provided with a taper of some kind, arranged to cooperate with the flange 17 of the first housing 2. The flange 17 can function as an end stop for the second housing 4 of the drive unit 3, and can also centre the second housing when it is the drive position. The shape of the edge 18 and the flange 17 is preferably the same, such that they can cooperate with each other with a form fit. The shape of the flange may be straight or may be tapered with an angle relative to the vertical axis 19 of the drive unit. In one example, the flange is tapered with a 45 degrees angle, and the edge 18 is consequently provided with a 45 degrees angle. Other angles or shapes are also possible, such as a wedge shape. The flange and/or the edge may also be provided with a seal of some type.

A marine propulsion system 6 is attached to the lower side 15 of the second housing 4. The marine propulsion system 6 comprises a leg 7 and a hub 8 and may be provided with a single propeller 9 or with two counter-rotating propellers 9, depending on the drive installation. The drive shaft of the drive unit extends through the leg and the hub is provided with a bevel gear which transfers the rotation of the drive motor to the propeller. In a double propeller installation, concentric drive shafts are used.

The position of the drive unit 3 is adjusted with an adjustment mechanism 10 which is arranged at the upper part of the drive unit. The adjustment mechanism may e.g. comprises one or more linear actuators, such as hydraulic cylinders or electric linear actuators. The adjustment mechanism may also comprise a threaded pin running in a threaded nut attached to the second housing.

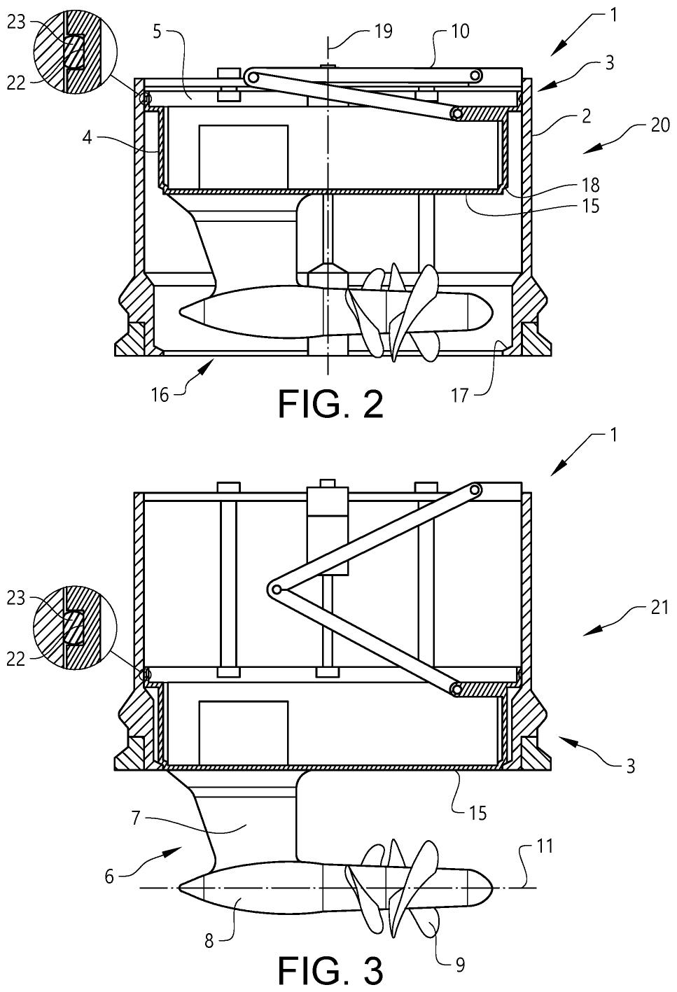

The drive unit 1 can be set in different positions. One position is a parking position 20, shown in FIG. 2, in which the drive unit 1 and the marine propulsion system 6 is positioned completely inside the first housing 2. In this position, the complete drive unit is positioned within the first housing 2 and thus within the hull of the marine vessel, such that the propeller is completely concealed. In this position, the marine propulsion system and the propeller will not induce any drag which is of advantage when sailing. This may also be an advantage when the vessel is transported. A further advantage is that the marine propulsion system is less prone to be subjected to biofouling. By filling the space with a gas, such as air or exhaust gas, the biofouling problem is further minimized. The gas can comprise one or more components counteracting biofouling, such as pure oxygen or one or more pesticides that prevent build-up of for instance anemones and algae.

The drive unit 1 is also provided with a drive position 21, shown in FIG. 3, in which the lower side 15 of the second housing 4 of the drive unit 1 is aligned with the hull 31 of the vessel 30. In the drive position, the leg 7 extends completely into the water. This position resembles a fixed, regular installation of a saildrive on a sailboat. This position is used when the boat is driven by the motor, and can also be used when the battery 13 needs to be charged when sailing.

The drive system is provided with a programmable automatic cleaning sequence that is used when the marine vessel is parked and when the drive unit is in the parking position. The purpose of the programmable automatic cleaning sequence is to remove contaminations and biofouling in a regular manner, such that e.g. barnacles will not be able to stick to the inner of the first housing and start to grow. The programmable cleaning sequence can also be used when the boat has been subjected to contaminated water, such as muddy water, or has been driving through seaweed or algae, etc.

The programmable cleaning sequence is initiated when the marine vessel is standing still. The programmable cleaning sequence for a motorboat is e.g. initiated when the motorboat has been parked for a predetermined time. A programmable cleaning sequence may also be initiated when the drive unit has not been used for a predetermined time. For a sailboat that is sailing and not using the drive unit at all, the programmable cleaning sequence may e.g. be initiated when the sailboat is parked after the sailing, even if the sailboat has only been parked for a short time.

In the cleaning sequence, the drive unit 3 is moved automatically from the parking position 20 to the drive position 21 and back to the parking position 20. In this way, the drive unit 3, and thereby the second housing 4, moves relative to the first housing 2 during the cleaning sequence. The second housing 4 comprises at an upper end of the second housing 4, a groove 22 into which one or more seal elements 23 are placed. When the second housing 4 moves relative the first housing 2, any contaminations and biofouling on the inside of the first housing 2 is mechanically removed. Further, when in the drive position 21, the flange 17 of the first housing 2 the edge 18 of the lower side 15 of the second housing 4 are clamped together and crushes any contaminations and biofouling on the flange 17 and edge 18.

The one or more seal elements 23 may be a scraper ring, a guiding ring or a sealing ring. When using a scraper ring, this assists in the mechanical removal of any contaminations and biofouling on the inside of the first housing 2.

In the cleaning sequence, when the drive unit 3 is in the drive position 21, the propeller or propellers 9 may be rotated using a reduced torque. In this way, contaminations and biofouling on the propeller 9 and the shaft driving the propeller can be mechanically removed from the rotation. In case a larger build-up is present, the reduced torque will ensure that no damage is done to the propeller or shaft.

The programmable cleaning sequence may be performed once or may be repeated several times. When the marine vessel is parked, the cleaning sequence is performed automatically with a predetermined interval that can be set by the manufacturer of the boat or may be set by the user of the boat. The time interval is in one example once a day, i.e. a time interval of around 24 hours. Other suitable time intervals may be e.g. every second day or once a week.

The time interval may also be set depending on environmental parameters. The time of the year is one parameter. Other parameters are e.g. the geographical position, the type of water or the temperature of the water. All these parameters may influence the cleaning need of the drive system. The time of the year and the geographical position will e.g. determine the amount of different marine vegetation and marine animals that may grow and pollute the drive system. Barnacles is one such example, which will give more problems at some locations and at some time periods of the year. They will e.g. often settle and grow in autumn. A programmable cleaning sequence could also be used to prohibit ice built up or freezing in the winter.

The height position of the drive unit 1 may be controlled manually by a user, or may be automatically controlled. A user may e.g. initiate a cleaning sequence manually. The height position of the drive unit may also be controlled automatically by an ECU 12, e.g. to initiate a cleaning sequence.

The drive unit 3 is in on example rotationally fixed in the first housing 2, such that it cannot rotate and such that the propeller is directed in a fixed orientation. This will resemble a regular saildrive installation of a sailboat and is used when the vessel is steered with a rudder. In another example, the drive unit is rotationally adjustable such that the propeller can be directed in any desired direction. In this example, the drive unit can be used to steer the boat. It would also be possible to provide a marine vessel with two or more rotationally controllable drive systems 1 in order to increase the direction control of the vessel.

The invention is not to be regarded as being limited to the embodiments described above, a number of additional variants and modifications being possible within the scope of the subsequent patent claims.

1. A drive system for a marine vessel comprising a first housing fixed to an opening in a hull of the marine vessel, and a drive unit arranged inside the first housing, where the drive unit is provided with a second housing comprising a drive motor and a marine propulsion system attached to the second housing, where the marine propulsion system comprises a leg and a hub provided with at least one propeller, where the drive system comprises an adjustment mechanism arranged to adjust the position of the drive unit in the first housing, where the drive system is provided with a parking position in which the marine propulsion system is positioned inside the first housing and a drive position in which the marine propulsion system is positioned outside of the first housing, characterized in that the drive system is provided with a programmable automatic cleaning sequence in which the drive unit is moved from the parking position to the drive position and back to the parking position at least once when the marine vessel is parked with the drive unit in the parking position, where the cleaning sequence is adapted to mechanically clean the inside of the first housing from the movement of the drive unit from the parking position to the drive position back to the parking position.

2. Drive system according to claim 1, wherein the drive motor is an electric drive motor.

3. Drive system according to claim 1, wherein the drive motor is an internal combustion engine.

4. Drive system according to claim 1, wherein the programmable cleaning sequence is programmed to be performed with a predetermined interval when the marine vessel is parked.

5. Drive system according to claim 4, wherein the predetermined interval is less than 48 hours.

6. Drive system according to claim 4, wherein the predetermined interval is less than 24 hours.

7. Drive system according to claim 1, wherein the cleaning sequence is repeated at least two times.

8. Drive system according to claim 1, wherein the first housing and the second housing is cylindrical.

9. Drive system according to claim 1, wherein the shape of the first housing and the second housing is non-cylindrical, having an oval shape, an elliptical shape, a parallelogram shape or a prismatic shape.

10. Drive system according to claim 1, wherein the adjustment mechanism arranged to adjust the position of the drive unit in the first housing is adapted to be controlled automatically by an ECU of the vessel.

11. Drive system according to claim 1, wherein the drive unit is provided with a gas pressure source having an outlet in the lower side of the second housing, such that gas can be inserted into the first housing when the drive unit is in the parking position.

12. Drive system according to claim 11, wherein the gas comprises one or more components counteracting biofouling.

13. Drive system according to claim 1, wherein the hub is provided with two propellers.

14. Drive system according to claim 1, wherein the drive system is provided with a locking means that is adapted to lock the adjustment mechanism in the selected position.

15. Marine vessel, comprising at least one drive system according to claim 1.
